(19) United States
(12) Patent Application Publication
(10) Pub. No.: US 2024/0068851 A1
(43) Pub. Date: Feb. 29, 2024

(54) METHOD, APPARATUS, AND PARAMETER TRAINING METHOD FOR FRICTION LOSS-BASED DIFFERENTIAL PRESSURE FLOW RATE MEASUREMENT

(71) Applicant: ELECTRONICS AND TELECOMMUNICATIONS RESEARCH INSTITUTE, Daejeon (KR)

(72) Inventors: Jongwoo CHOI, Seoul (KR); Wan Ki PARK, Daejeon (KR); JINSOO HAN, Daejeon (KR)

(21) Appl. No.: 18/236,580

(22) Filed: Aug. 22, 2023

(30) Foreign Application Priority Data
Aug. 24, 2022 (KR) 10-2022-0106493
Jun. 26, 2023 (KR) 10-2023-0081838

(51) Int. Cl. G01F 1/36; G01F 15/02

(52) U.S. Cl. CPC G01F 1/363; G01F 15/02

(57) ABSTRACT

Provided are a method, an apparatus, and a parameter training method for friction loss-based differential pressure flow rate measurement. The method includes receiving pipe information on a pipe through which fluid passes from a measurement sensor installed on the pipe, calculating physical properties of the fluid based on the pipe information, obtaining a first parameter related to pressure loss of the fluid that occurs in a first passing route in the pipe, obtaining a second parameter related to pressure loss of the fluid that occurs in a second passing route in the pipe, and outputting a flow rate of the fluid based on the pipe information, the physical properties of the fluid, the first parameter, and the second parameter.

### CROSS-REFERENCE TO RELATED APPLICATIONS

This application claims the benefit of Korean Patent Application No. 10-2022-0106493 filed on Aug. 24, 2022, and Korean Patent Application No. 10-2023-0081838 filed on Jun. 26, 2023, in the Korean Intellectual Property Office, the entire disclosures of which are incorporated herein by reference for all purposes.

### BACKGROUND

### 1. Field of the Invention

One or more embodiments relate to a method, an apparatus, and a parameter training method for friction loss-based differential pressure flow rate measurement.

### 2. Description of Related Art

A flow meter is an apparatus for measuring velocity or flow rate of fluid. Phases of fluid (e.g., liquid, gas, and multiphase), properties of fluid (e.g., density, viscosity, and turbidity), and flow rate level can vary greatly depending on a system to be measured. Various types of flow meters are developed to measure flow rate under various conditions regarding phases of fluid, properties of fluid, and flow rate level.

A flow meter that measures volumetric flow rate for the liquid phase may include a magnetic flow meter, an ultrasonic flow meter, and a differential pressure flow meter.

The magnetic flow meter measures flow rate using the voltage difference generated in conducting fluid under a magnetic field. The magnetic flow meter has high flow rate measurement accuracy, but a portion of a pipe should be replaced due to the size of an apparatus for applying the magnetic field to the fluid and the unit cost of the flow meter itself is high.

The ultrasonic flow meter measures flow rate using a transit time or change in frequency according to the Doppler shift when ultrasonic waves are applied to fluid The ultrasonic flow meter is easy to install but has a high unit cost and low accuracy.

The differential pressure flow meter (e.g., a venturi flow meter and an orifice flow meter) measures flow rate using a pressure difference according to a cross-sectional area change of a pipe which the fluid passes through. The differential pressure flow meter has a low unit cost, but an additional apparatus (e.g., an apparatus that may cause a change in a cross-sectional area in a pipe) may be installed in a pipe. The additional apparatus may disturb flow of fluid. When the additional apparatus is installed in the pipe, it may be difficult to install the differential pressure flow meter. Flow rate measurement accuracy using the differential pressure flow meter may also not be high.

The above description has been possessed or acquired by the inventor(s) in the course of conceiving the present disclosure and is not necessarily an art publicly known before the present application is filed.

### SUMMARY

In order to increase the convenience of installation without disturbing flow of fluid when the flow rate of liquid phase flow in a pipe is measured, friction loss-based differential pressure flow measurement technology is required.

Embodiments provide technology for measuring a flow rate based on parameters related to pressure loss of fluid that occurs in a passing route in a pipe through which the fluid flows.

Embodiments provide technology for training the parameters by comparing flow rate measured from a flow rate measurement apparatus with actual flow rate.

However, technical aspects are not limited to the foregoing aspects, and there may be other technical aspects.

According to an aspect, there is provided a method of measuring a flow rate. The method includes receiving pipe information on a pipe through which fluid passes from a measurement sensor installed on the pipe. The pipe information may include information on pressure of the fluid, information on temperature of the fluid, and control state information corresponding to a control state of an apparatus installed inside or outside the pipe. The measurement sensor may include a pressure gauge configured to measure the pressure of the fluid, a thermometer configured to measure the temperature of the fluid, and a control state measuring instrument configured to measure the control state of the apparatus installed inside or outside the pipe.

The method includes calculating physical properties of the fluid based on the pipe information.

The method includes obtaining a first parameter related to pressure loss of the fluid that occurs in a first passing route in the pipe. The first passing route may be a route not including the apparatus installed inside or outside the pipe among the routes through which the fluid passes through the pipe

The method includes obtaining a second parameter related to pressure loss of the fluid that occurs in a second passing route in the pipe. The second passing route may be a route including the apparatus installed inside or outside the pipe among the routes through which the fluid passes through the pipe.

The method includes outputting a flow rate of the fluid based on the pipe information, the physical properties of the fluid, the first parameter, and the second parameter.

The first parameter may include a diameter of the pipe, roughness of an inner surface of the pipe, and a distance between pressure gauges.

The second parameter may include a calculation formula of a pressure loss coefficient of the apparatus according to the control state information.

The outputting of the flow rate of the fluid may include obtaining a friction coefficient of the pipe, which is necessary for calculating the flow rate of the fluid passing through the pipe, based on the physical properties of the fluid and the first parameter.

The outputting of the flow rate of the fluid may include obtaining a pressure loss coefficient of the apparatus based on the control state information and the second parameter.

The outputting of the flow rate of the fluid may include generating a flow rate calculation model for calculating a flow velocity of the fluid passing through the pipe, based on the pipe information, the physical properties of the fluid, the first parameter, and the second parameter. The outputting of the flow rate of the fluid may include obtaining the flow velocity of the fluid by analyzing the flow rate calculation model. The outputting of the flow rate of the fluid may include outputting the flow rate of the fluid based on the flow velocity of the fluid.

The obtaining of the flow velocity of the fluid may include analyzing the flow rate calculation model using one of an analytical method, a numerical method, and a model estimation method.

According to another aspect, there is provided an apparatus for measuring a flow rate of fluid. The apparatus includes a memory configured to store one or more instructions, and a processor configured to execute the instructions, wherein the processor may be configured to perform a plurality of operations when the instructions are executed.

The plurality of operations may include receiving pipe information on a pipe through which fluid passes from a measurement sensor installed on the pipe. The pipe information may include information on pressure of the fluid, information on temperature of the fluid, and control state information corresponding to a control state of an apparatus installed inside or outside the pipe. The measurement sensor may include a pressure gauge configured to measure the pressure of the fluid, a thermometer configured to measure the temperature of the fluid, and a control state measuring instrument configured to measure the control state of the apparatus installed inside or outside the pipe.

The plurality of operations may include calculating physical properties of the fluid based on the pipe information.

The plurality of operations may include obtaining a first parameter related to pressure loss of the fluid that occurs in a first passing route of the fluid in the pipe. The first passing route may be a route not including the apparatus installed inside or outside the pipe among routes through which the fluid passes through the pipe

The plurality of operations may include obtaining a second parameter related to pressure loss of the fluid that occurs in a second passing route of the fluid in the pipe. The second passing route may be a route including the apparatus installed inside or outside the pipe among routes through which the fluid passes through the pipe.

The plurality of operations may include outputting a flow rate of the fluid based on the pipe information, the physical properties of the fluid, the first parameter, and the second parameter.

The first parameter may include a diameter of the pipe, roughness of an inner surface of the pipe, and a distance between pressure gauges.

The second parameter may include a calculation formula of a pressure loss coefficient of the apparatus according to the control state information.

The outputting of the flow rate of the fluid may include obtaining a friction coefficient of the pipe, which is necessary for calculating the flow rate of the fluid passing through the pipe, based on the physical properties of the fluid and the first parameter.

The outputting of the flow rate of the fluid may include obtaining a pressure loss coefficient of the apparatus, which is necessary for calculating the flow rate of the fluid passing through the apparatus, based on the control state information and the second parameter.

The outputting of the flow rate of the fluid may include generating a flow rate calculation model for calculating a flow velocity of the fluid passing through the pipe, based on the pipe information, the physical properties of the fluid, the first parameter, and the second parameter. The outputting of the flow rate of the fluid may include obtaining the flow velocity of the fluid by analyzing the flow rate calculation model. The outputting of the flow rate of the fluid may include outputting the flow rate of the fluid based on the flow velocity of the fluid.

The obtaining of the flow velocity of the fluid may include analyzing the flow rate calculation model using one of an analytical method, a numerical method, and a model estimation method.

According to another aspect, there is provided a parameter training method that includes receiving an actual flow rate from a flow meter installed in a pipe through which fluid passes. The parameter training method includes training a first parameter related to pressure loss of the fluid and a second parameter by comparing flow rate measured from a flow rate measurement apparatus with the actual flow rate. The parameter training method includes storing the trained first parameter and the trained second parameter in a memory. The first parameter may be related to pressure loss of the fluid that occurs in a first passing route in the pipe, and the second parameter may be related to pressure loss of the fluid that occurs in a second passing route in the pipe. The first passing route may be a route not including an apparatus installed inside or outside the pipe among routes through which the fluid passes through the pipe. The second passing route may be a route including the apparatus installed inside or outside the pipe among routes through which the fluid passes through the pipe.

The first parameter may include a diameter of the pipe, roughness of an inner surface of the pipe, and a distance between pressure gauges.

The second parameter may include a calculation formula of a pressure loss coefficient of the apparatus according to control state information.

The training of the first parameter and the second parameter may include training the first parameter and the second parameter through one of a gradient descent method or a genetic algorithm method, based on a difference between the flow rate measured from the flow rate measurement apparatus and the actual flow rate.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates a flow rate measurement apparatus and a pipe system according to an embodiment;

FIG. 2 is a diagram illustrating a flow rate measurement apparatus according to an embodiment;

FIG. 3 is a flowchart illustrating an example of a flow rate measurement method according to an embodiment;

FIG. 4 is a flowchart illustrating an example of a training method of a flow rate measurement apparatus according to an embodiment;

FIG. 5 is a diagram illustrating a training apparatus according to an embodiment; and

FIG. 6 illustrates an example of an apparatus according to an embodiment.

### DETAILED DESCRIPTION

The following detailed structural or functional description is provided as an embodiment only and various alterations and modifications may be made to embodiments. Here, embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or populations thereof.

Unless otherwise defined, all terms used herein including technical or scientific terms have the same meaning as commonly understood by one of ordinary skill in the art to which embodiments belong. Terms, such as those defined in commonly used dictionaries, should be construed to have meanings matching with contextual meanings in the relevant art and the present disclosure, and are not to be construed as an ideal or excessively formal meaning unless otherwise defined herein.

Hereinafter, embodiments will be described in detail with reference to the accompanying drawings. When describing the embodiments with reference to the accompanying drawings, like reference numerals refer to like elements and a repeated description related thereto will be omitted.

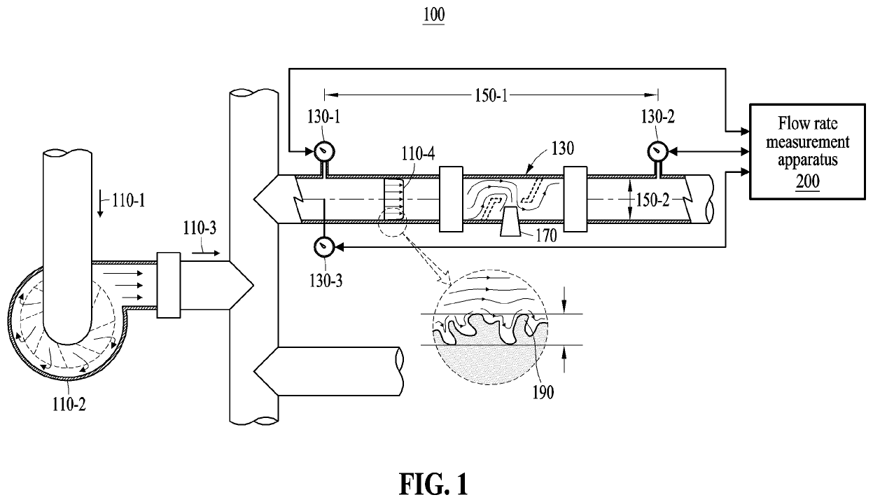

FIG. 1 illustrates a flow rate measurement apparatus and a pipe system according to an embodiment.

Referring to FIG. 1, a flow rate measurement apparatus 200 installed in a pipe system 100 may measure the volumetric flow rate in a pipe through which liquid flows. The pipe system 100 may include a general pipe system. For example, the pipe system 100 may include water, sewage, seawater, and oil refinery pipe systems.

The pipe system 100 may include a power facility 110-2, one or more measurement sensors, a pipe 130, and an apparatus 170 installed inside or outside the pipe 130, and the flow rate measurement apparatus 200.

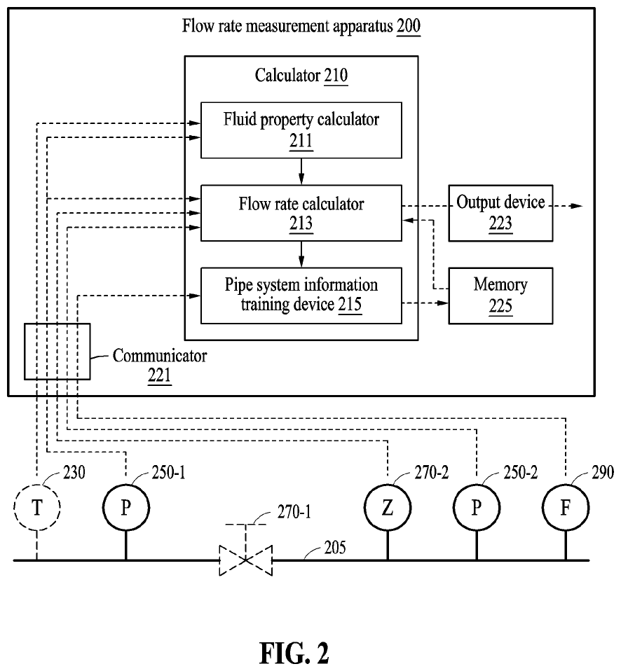

The measurement sensors may include pressure gauges 130-1 and 130-2, a thermometer 130-3, and a control state measuring instrument (e.g., 270-2 of FIG. 2). The pressure gauges 130-1 and 130-2 may measure the pressure of fluid in the pipe 130. The thermometer 130-3 may measure the temperature of the fluid in the pipe 130. The control state measuring instrument 270-2 may include a monitoring system (not shown) for a control state (or a control command) of the apparatus 170. The control state measuring instrument 270-2 may measure the control state of the apparatus 170.

The apparatus 170 may include a valve, a nozzle, a diffuser, an elbow, a strainer, a filter, and a heat exchanger or a combination thereof. However, embodiments are not limited thereto, and the apparatus 170 may include an apparatus installed inside or outside the pipe 130 included in the pipe system 100.

The pipe system 100 may generate flow of fluid using a position difference of the fluid, a pressure difference, and/or the power facility 110-2. The position difference and pressure difference of the fluid may be caused by a structure (not shown) applied to the pipe system 100. The power facility 110-2 may include a centrifugal pump and/or a positive-displacement pump. The structure (not shown) applied to the pipe system 100 and the power facility 110-2 may deliver energy to an input fluid 110-1 and may discharge fluid 110-3. The discharged fluid 110-3 may be branched into each pipe 130.

The pipe 130 may have a unique diameter 150-2 and a roughness 190 of the inner surface of the pipe 130. When the pipe 130 is not circular, the diameter 150-2 may be a hydraulic diameter.

As the fluid flows in the pipe 130, flow 110-4 may occur. The flow 110-4 may be affected by wall friction between the inner surface of the pipe 130 and the fluid. The flow 110-4 may be affected by shear stress caused by viscosity of the fluid. The flow 110-4 may have flow velocity distribution in the radial direction due to the wall friction and the shear stress. Here, an average flow velocity based on a cross-sectional area and flow rate to be measured may be expressed as in Equation 1 below.

Q=πD²V/4 [Equation 1]

Here, in Equation 1, Q denotes the flow rate to be measured, V denotes the flow velocity of the fluid, and D denotes the unique diameter 150-2 of the pipe 130.

As the fluid passes through the first passing route in the pipe 130, shear stress applied to the flow 110-4 may be generated. The first passing route may be a route not including the apparatus 170 among the routes through which the fluid passes through the pipe 130. Wall friction due to the shear stress may cause pressure loss. The pressure loss may be defined as a function of a friction coefficient of the pipe 130 and a first parameter. The friction coefficient of the pipe 130 may be a coefficient to represent the pressure lost while the fluid passes through the first passing route. The first parameter may include a parameter related to the pressure loss of the fluid that occurs in the first passing route in the pipe 130. For example, the first parameter may include the diameter 150-2 of the pipe 130, the roughness 190 of the inner surface of the pipe 130, and a distance 150-1 between the pressure gauges 130-1 and 130-2.

As the fluid passes through the second passing route in the pipe 130, shear stress applied to the flow 110-4 may be generated. The second passing route may be a route including the apparatus 170 among the routes through which the fluid passes through the pipe 130. Wall friction due to the shear stress may cause pressure loss. The pressure loss may be defined as a function of a pressure loss coefficient of the apparatus 170 and the second parameter. The pressure loss coefficient of the apparatus 170 may be a coefficient to represent the pressure lost while the fluid passes through the apparatus 170 on the second passing route. The second parameter may include a parameter related to the pressure loss of the fluid that occurs in the second passing route in the pipe 130. For example, the second parameter may include a calculation formula of the pressure loss coefficient of the apparatus 170 according to control state information.

The flow rate measurement apparatus 200 may calculate the flow rate of the fluid based on a pressure loss, the friction coefficient of the pipe 130, the pressure loss coefficient of the apparatus 170, the first parameter, and the second parameter. The pressure loss may be measured by the pressure gauges 130-1 and 130-2. For example, the pressure loss may be a difference between a first pressure measured by the pressure gauge 130-1 and a second pressure measured by the pressure gauge 130-2. The pressure loss may be proportional to the distance 150-1 between the pressure gauges 130-1 and 130-2.

The pressure gauges 130-1 and 130-2 may be installed at any position in the pipe 130 to be measured.

For example, when the pressure gauges 130-1 and 130-2 are installed on a straight pipe, the flow rate measurement apparatus 200 may calculate the flow rate of the fluid based on the pressure loss, the friction coefficient of the pipe 130, and the first parameter. As another example, when the pressure gauges 130-1 and 130-2 are installed right before and after the apparatus 170, the flow rate measurement apparatus 200 may calculate the flow rate of the fluid based on the pressure loss, the pressure loss coefficient of the apparatus 170, and the second parameter. As another example, when the pressure gauges 130-1 and 130-2 are installed at any position (e.g., the first passing route and the second passing route) of the pipe 130, the flow rate measurement apparatus 200 may calculate the flow rate based on the pressure loss, the friction coefficient of the pipe 130, the pressure loss coefficient of the apparatus 170, the first parameter, and the second parameter.

The physical properties of the fluid may change depending on the pressure and temperature of the fluid. A degree (or a level) of the effect of the pressure and temperature of the fluid on the physical properties of the fluid may vary depending on the phase of the fluid and the physical properties of the fluid. For example, the physical properties of fluid in a liquid phase fluid may be affected more by the temperature of the fluid than the pressure of the fluid. The flow rate measurement apparatus 200 may calculate the physical properties of the fluid using the temperature of the fluid measured by the thermometer 130-3.

The physical properties of the fluid may include density and viscosity. The density and viscosity of the fluid may change depending on the pressure and temperature of the fluid.

FIG. 2 is a diagram illustrating a flow rate measurement apparatus according to an embodiment.

Referring to FIG. 2, a pipe 205 may be the pipe 130 shown in FIG. 1. In addition, measurement sensors 230, 250-1, 250-2, and 270-2 may include the measurement sensors 130-1, 130-2, and 130-3 shown in FIG. 1. The flow rate measurement apparatus 200 may receive pipe information on the pipe 205 through which the fluid passes from the measurement sensors 230, 250-1, 250-2, and 270-2 installed on the pipe 205.

The pipe information may include information on pressure of fluid, information on temperature of the fluid, and control state information. The control state information may include information corresponding to a control state of an apparatus 270-1. The apparatus 270-1 may be installed inside or outside the pipe 205. For example, the control state information may include information associated with the opening rate level of a valve.

The flow rate measurement apparatus 200 may calculate the physical properties of the fluid based on the pipe information. The flow rate measurement apparatus 200 may obtain a first parameter and a second parameter. The first parameter may include a parameter related to pressure loss of the fluid that occurs in a first passing route in the pipe 205. The second parameter may include a parameter related to pressure loss of the fluid that occurs in a second passing route in the pipe 205. The flow rate measurement apparatus 200 may output the flow rate of the fluid based on the pipe information, the physical properties of the fluid, the first parameter, and the second parameter.

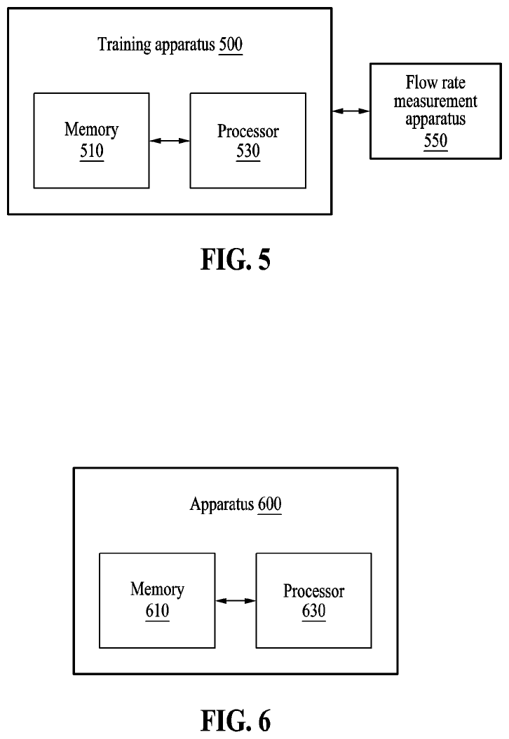

The flow rate measurement apparatus 200 may include a calculator 210, a communicator 221, an output device 223, and a memory 225. The calculator 210 may include a fluid property calculator 211, a flow rate calculator 213, and a pipe system information training device 215. However, the configuration of the flow rate measurement apparatus 200 is not limited thereto, and the flow rate measurement apparatus 200 may include only some of the calculator 210, the communicator 221, the output device 223, and the memory 225 or may include an additional apparatus (not shown). In addition, the pipe system information training device 215 may be included in a separate training device (e.g., a training apparatus 500 of FIG. 5) or may be included in the flow rate measurement apparatus 200.

The communicator 221 may receive the pipe information from the measurement sensors. The measurement sensors may include pressure gauges 250-1 and 250-2, a thermometer 230, and a control state measuring instrument 270-2. The pressure gauges 250-1 and 250-2 may measure the pressure of the fluid. The thermometer 230 may measure the temperature of the fluid. The control state measuring instrument 270-2 may measure the control state of the apparatus 270-1 installed inside or outside the pipe 205. For example, the communicator 221 may receive the information on the pressure of the fluid from the pressure gauges 250-1 and 250-2. As another example, the communicator 221 may receive the information on the temperature of the fluid from the thermometer 230. As another example, the communicator 221 may receive information on the control state of the apparatus 270-1 installed inside or outside the pipe 205 from the control state measuring instrument 270-2.

The communicator 221 may output the received pipe information to the calculator 210. The communicator 221 may perform communication using a wired/wireless analog signal and a digital signal. However, a communication method of the communicator 221 is not limited thereto.

The calculator 210 may receive the pipe information from the communicator 221. The calculator 210 may calculate the flow rate of the fluid based on the pipe information received from the communicator 221. The calculator 210 may include the fluid property calculator 211, the flow rate calculator 213, and a pipe system information training device 215.

The fluid property calculator 211 may calculate the physical properties of the fluid based on the pipe information. The fluid property calculator 211 may calculate the physical properties of the fluid based on the information on the pressure of the fluid. The fluid property calculator 211 may use the information on the temperature of the fluid to accurately calculate the physical properties of the fluid. In addition, the fluid property calculator 211 may use the information on the control state of the apparatus 270-1. The physical properties of the fluid may include density and viscosity of the fluid. The fluid property calculator 211 may output the calculated properties of the fluid to the flow rate calculator 213.

For example, the fluid property calculator 211 may calculate the physical properties of the fluid by substituting a measured pressure and a measured temperature into a diagram of the physical properties of the fluid according to pressure and temperature conditions. As another example, the fluid property calculator 211 may calculate the physical properties of the fluid using a formula. As another example, the fluid property calculator 211 may calculate the physical properties of the fluid based on a user's input or a reference value under a standard condition.

The flow rate calculator 213 may receive the physical properties of the fluid from the fluid property calculator 211. The flow rate calculator 213 may calculate the flow rate of the fluid based on the pipe information, the physical properties of the fluid, the first parameter, and the second parameter.

The flow rate calculator 213 may obtain the first parameter. For example, the flow rate calculator 213 may obtain the first parameter through an input from a user. As another example, the flow rate calculator 213 may obtain the first parameter stored from the memory 225.

When the apparatus 270-1 is in the pipe 205, the flow rate calculator 213 may obtain the second parameter. For example, the flow rate calculator 213 may obtain the second parameter through an input from a user. As another example, the flow rate calculator 213 may obtain the second parameter stored from the memory 225.

The memory 225 may store information on the first parameter and the second parameter. The memory 225 may be a hard disk drive (HDD), a solid state drive (SSD), a non-volatile memory such as an optical disk, or a volatile memory such as random access memory (RAM). For example, the memory 225 may store the information on the first parameter and the second parameter in a database, an input/output file, or a variable method in the memory 225.

The flow rate calculator 213 may obtain a friction coefficient of the pipe 205 based on the physical properties of the fluid and the first parameter. The friction coefficient of the pipe 205 may include a coefficient that is necessary for calculating the flow rate of the fluid passing through the pipe 205. For example, the friction coefficient of the pipe 205 may be the density of the fluid, the viscosity of the fluid, the diameter of the pipe 205 (e.g., 150-2 of FIG. 1), roughness (e.g., 190 of FIG. 1) of the inner surface of the pipe 205, and a function for the flow velocity of the fluid. As another example, the friction coefficient of the pipe 205 may be a diagram using a Moody diagram. As another example, the friction coefficient of the pipe 205 may be expressed as Equation 2 below.

$$\frac{1}{\sqrt{f}} = - 2 {log}_{10} ( \frac{ε / D}{3.7} + \frac{2.51}{\sqrt{f}} \frac{μ}{ρ VD} ) \qquad [ Equation 2 ]$$

Here, in Equation 2, f denotes the friction coefficient of the pipe 205, p denotes the density of the fluid, F denotes the roughness 190 of the inner surface of the pipe 205, D denotes the diameter (e.g., 150-2 of FIG. 1) of the pipe 205, and V denotes the flow velocity of the fluid.

The flow rate calculator 213 may obtain a pressure loss coefficient of the apparatus 270-1 based on the control state information and the second parameter. The pressure loss coefficient of the apparatus 270-1 may include a coefficient necessary for calculating the flow rate of the fluid passing through the apparatus 270-1.

The flow rate calculator 213 may generate a flow rate calculation model based on the pipe information, the physical properties of the fluid, the first parameter, and the second parameter. The flow rate calculation model may include a model for calculating the flow velocity of the fluid. For example, the flow rate calculation model may be expressed as Equation 3 below.

$$F = ( f \frac{L}{D} + {K}_{L} ) \frac{{V}^{2}}{2} - \frac{{P}_{inlet} - {P}_{outlet}}{ρ} = 0 \qquad [ Equation 3 ]$$

Here, in Equation 3, L denotes the distance 150-1 between the pressure gauges 130-1 and 130-2, D denotes the diameter 150-2 of the pipe 205, V denotes the flow velocity of the fluid, K_{L} denotes the pressure loss coefficient of the apparatus 270-1, f denotes the friction coefficient of the pipe 205, p denotes the density of the fluid, Pᵢₙₗₑₜ denotes the pressure of the fluid before the pressure loss occurs measured by the pressure gauge 130-1, and Pₒᵤₜₗₑₜ denotes the pressure of the fluid after the pressure loss occurs measured by the pressure gauge 130-2.

The flow rate calculator 213 may obtain the flow velocity of the fluid by analyzing the flow rate calculation model. The flow rate calculator 213 may calculate the flow rate of the fluid based on the flow velocity of the fluid. For example, the flow calculator 213 may analyze the flow rate calculation model using one of an analytical method, a numerical method, and a model estimation method. The flow rate calculator 213 may transmit the calculated flow rate or the flow velocity of the fluid to the output device 223.

The output device 223 may receive the calculated flow rate from the flow rate calculator 213. The output device 223 may output the received flow rate to a display (not shown) or other device (not shown). The display device may exist outside or inside the flow rate measurement apparatus 200.

The flow rate calculator 213 may use a measured value of an additional flow meter 290 for evaluation of the accuracy of the calculated flow rate. The pipe system information training device 215 of the flow rate calculator 213 may use the measured value of the additional flow meter 290 when an actual flow rate is necessary for training of parameters (e.g., the first parameter and the second parameter). The additional flow meter 290 may be a clamp-on ultrasonic flow meter, which is easy to install and remove. The additional flow meter 290 may be installed in the pipe 205 for a purpose of performing evaluation or training. The additional flow meter 290 may be removed after the purpose of installation is achieved. However, embodiments are not limited thereto.

The flow rate calculator 213 may check whether the training of the first parameter and the second parameter is necessary. When the training of the first parameter and the second parameter is required, the pipe system information training device 215 may train the first parameter and the second parameter. The pipe system information training device 215 may receive an actual flow rate from the additional flow meter 290. The pipe system information training device 215 may train the first parameter and the second parameter by comparing the flow rate measured from the flow rate measurement apparatus 200 with the actual flow rate. The memory 225 may store the first parameter and the second parameter trained through the pipe system information training device 215.

For example, the pipe system information training device 215 may train the first parameter and the second parameter that may minimize an error between the flow rate measured from the flow rate measurement apparatus 200 and the actual flow rate measured from the additional flow meter 290. The pipe system information training device 215 may train the first parameter and the second parameter through one of a gradient descent method or a genetic algorithm method. However, the training method is not limited thereto.

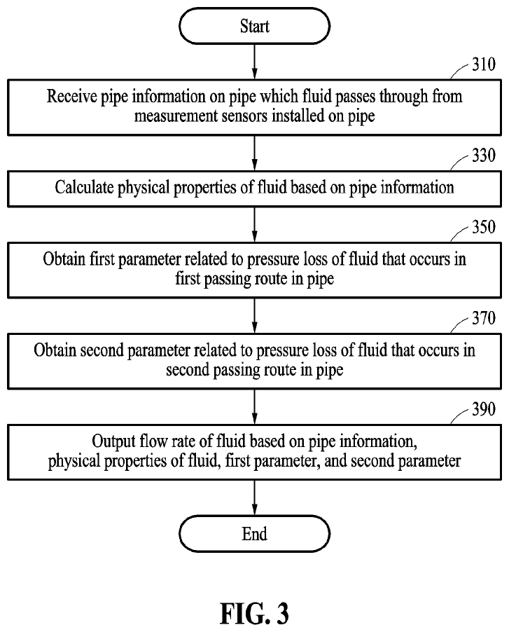

FIG. 3 is a flowchart illustrating an embodiment of a flow rate measurement method according to an embodiment.

Referring to FIG. 3, in operation 310, the flow rate measurement apparatus 200 may receive pipe information on a pipe (e.g., 130 of FIG. 1 or 205 of FIG. 2) through which fluid passes from measurement sensors (e.g., 130-1, 130-2, and 130-3 of FIG. 1 or 230, 250-1, 250-2, and 270-2 of FIG. 2) installed on the pipe.

In operation 330, the flow measurement apparatus 200 may calculate the physical properties of the fluid based on the pipe information.

In operation 350, the flow rate measurement apparatus 200 may obtain a first parameter related to pressure loss of the fluid that occurs in a first passing route in the pipe 130 or 205.

In operation 370, the flow rate measurement apparatus 200 may obtain a second parameter related to pressure loss of the fluid that occurs in a second passing route in the pipe 130 or 205.

In operation 370, the flow rate measurement apparatus 200 may output the flow rate of the fluid based on the pipe information, the physical properties of the fluid, the first parameter, and the second parameter.

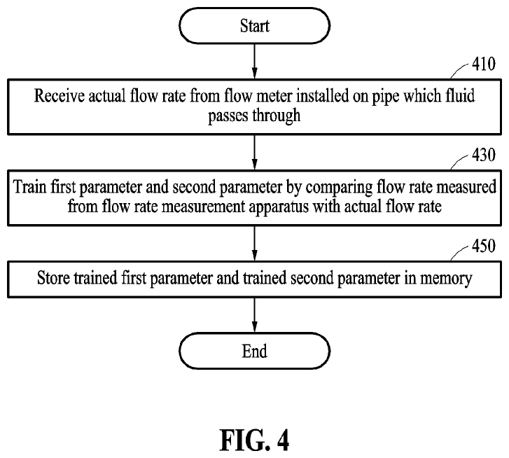

FIG. 4 is a flowchart illustrating an embodiment of a training method of a flow rate measurement apparatus according to an embodiment.

Referring to FIG. 4, in operation 410, a training apparatus (e.g., the pipe system information training device 215 of FIG. 2 or the training apparatus 500 of FIG. 5) may receive the actual flow rate from a flow meter (e.g., 290 of FIG. 2) installed on a pipe through which fluid passes.

In operation 430, the training apparatus 500 may train a first parameter and a second parameter by comparing the flow rate measured from a flow rate measurement apparatus (e.g., the flow rate measurement apparatus 200 of FIG. 2 or a flow rate measurement apparatus 550 of FIG. 5) with the actual flow rate.

In operation 450, the training apparatus 500 may store the trained first parameter and the trained second parameter in a memory (e.g., 225 of FIG. 2 or 510 of FIG. 5).

FIG. 5 is a diagram illustrating a training apparatus according to an embodiment.

Referring to FIG. 5, a training apparatus 500 may train a flow rate measurement apparatus 550. The flow rate measurement apparatus 550 may be the flow rate measurement apparatus 200 of FIG. 2. The training apparatus 500 may include a memory 510 and a processor 530.

The memory 510 may store instructions (or programs) executable by the processor 530. For example, the instructions may include instructions for performing an operation of the processor 530 and/or an operation of each component of the processor 530.

The processor 530 may process data stored in the memory 510. The processor 530 may execute computer-readable code (e.g., software) stored in the memory 510 and instructions triggered by the processor 530.

The processor 530 may be a hardware-implemented data processing device having a circuit that is physically structured to execute desired operations. For example, the desired operations may include code or instructions in a program.

For example, the hardware-implemented data processing device may include, for example, a microprocessor, a central processing unit (CPU), a processor core, a multi-core processor, a multiprocessor, an application-specific integrated circuit (ASIC), and a field-programmable gate array (FPGA).

The pipe system information training device 215 of FIG. 2 may be stored in the memory 510 and executed by the processor 530 or embedded in the processor 530. The processor 530 may perform the operation of the pipe system information training device 215 in substantially the same manner as described with reference to FIGS. 2 and 4. Accordingly, a further description thereof is omitted herein.

FIG. 6 illustrates an embodiment of an apparatus according to an embodiment.

Referring to FIG. 6, an apparatus 600 may include a memory 610 and a processor 630. The apparatus 600 may be the flow rate measurement apparatus 200 of FIG. 2. The apparatus 600 may be the training apparatus 500 of FIG. 5. In addition, the apparatus 600 may be an apparatus including both the flow rate measurement apparatus 200 and the training apparatus 500.

The memory 610 may store instructions (or programs) executable by the processor 630. For example, the instructions may include instructions for performing an operation of the processor 630 and/or an operation of each component of the processor 630.

The processor 630 may process data stored in the memory 610. The processor 630 may execute computer-readable code (e.g., software) stored in the memory 610 and instructions triggered by the processor 630.

The processor 630 may be a hardware-implemented data processing device having a circuit that is physically structured to execute desired operations. For example, the desired operations may include code or instructions in a program.

For example, the hardware-implemented data processing device may include, for example, a microprocessor, a CPU, a processor core, a multi-core processor, a multiprocessor, an ASIC, and an FPGA.

The flow rate measurement apparatus 200 of FIG. 2 and the training apparatus 500 of FIG. 5 may be stored in the memory 610 and executed by the processor 630 or embedded in the processor 630. The processor 630 may perform the operation of the flow rate measurement apparatus 200 and the operation of the training apparatus 500 in substantially the same manner as described with reference to FIGS. 1 to 5. Accordingly, a further description thereof is omitted herein.

The components described in the embodiments may be implemented by hardware components including, for example, at least one digital signal processor (DSP), a processor, a controller, an ASIC, an FPGA, other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using a hardware component, a software component and/or a combination thereof. A processing device may be implemented using one or more general-purpose or special-purpose computers, such as, for example, a processor, a controller, and an arithmetic logic unit (ALU), a DSP, a microcomputer, an FPGA, a programmable logic unit (PLU), a microprocessor, or any other device capable of responding to and executing instructions in a defined manner. The processing device may run an operating system (OS) and one or more software applications that run on the OS. The processing device may also access, store, manipulate, process, and create data in response to execution of the software. For purpose of simplicity, the description of the processing device is singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or one or more combinations thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the embodiments may be recorded in non-transitory computer-readable media including program instructions to implement various operations of the embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as read-only memory (ROM), RAM, flash memory, and the like. Examples of program instructions include both machine code, such as produced by a compiler, and files containing higher level code that may be executed by the computer using an interpreter.

The above-described hardware devices may be configured to act as one or more software modules in order to perform the operations of the above-described embodiments, or vice versa.

Although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Therefore, other implementations, other embodiments, and equivalents to the claims are also within the scope of the following claims.

What is claimed is:

1. A method of measuring a flow rate, the method comprising:
receiving pipe information on a pipe through which fluid passes from a measurement sensor installed on the pipe;
calculating physical properties of the fluid based on the pipe information;
obtaining a first parameter related to pressure loss of the fluid that occurs in a first passing route in the pipe;
obtaining a second parameter related to pressure loss of the fluid that occurs in a second passing route in the pipe; and
outputting a flow rate of the fluid based on the pipe information, the physical properties of the fluid, the first parameter, and the second parameter,
wherein the pipe information comprises information on pressure of the fluid, information on temperature of the fluid, and control state information corresponding to a control state of an apparatus installed inside or outside the pipe,
wherein the first passing route is a route not comprising the apparatus installed inside or outside the pipe among routes through which the fluid passes through the pipe, and
wherein the second passing route is a route comprising the apparatus installed inside or outside the pipe among routes through which the fluid passes through the pipe.

2. The method of claim 1, wherein the measurement sensor comprises:
a pressure gauge configured to measure the pressure of the fluid;
a thermometer configured to measure the temperature of the fluid; and
a control state measuring instrument configured to measure the control state of the apparatus installed inside or outside the pipe.

3. The method of claim 1, wherein the first parameter comprises a diameter of the pipe, roughness of an inner surface of the pipe, and a distance between pressure gauges.

4. The method of claim 1, wherein the second parameter comprises a calculation formula of a pressure loss coefficient of the apparatus according to the control state information.

5. The method of claim 1, wherein the outputting of the flow rate of the fluid comprises obtaining a friction coefficient of the pipe, which is necessary for calculating the flow rate of the fluid passing through the pipe, based on the physical properties of the fluid and the first parameter.

6. The method of claim 5, wherein the outputting of the flow rate of the fluid comprises obtaining a pressure loss coefficient of the apparatus, which is necessary for calculating the flow rate of the fluid passing through the apparatus, based on the control state information and the second parameter.

7. The method of claim 6, wherein the outputting of the flow rate of the fluid comprises:
generating a flow rate calculation model for calculating a flow velocity of the fluid based on the pipe information, the physical property of the fluid, the first parameter, and the second parameter;
obtaining the flow velocity of the fluid by analyzing the flow rate calculation model; and
outputting the flow rate of the fluid based on the flow velocity of the fluid.

8. The method of claim 7, wherein the obtaining of the flow velocity of the fluid comprises analyzing the flow rate calculation model using one of an analytical method, a numerical method, and a model estimation method.

9. An apparatus for measuring a flow rate of fluid, the apparatus comprising:
a memory configured to store one or more instructions; and
a processor configured to execute the instructions,
wherein the processor is configured to perform a plurality of operations when the instructions are executed,
wherein the plurality of operations comprises:
receiving pipe information on a pipe through which fluid passes from a measurement sensor installed on the pipe;
calculating physical properties of the fluid based on the pipe information;
obtaining a first parameter related to pressure loss of the fluid that occurs in a first passing route in the pipe;
obtaining a second parameter related to pressure loss of the fluid that occurs in a second passing route in the pipe; and
outputting a flow rate of the fluid based on the pipe information, the physical properties of the fluid, the first parameter, and the second parameter,
wherein the pipe information comprises information on pressure of the fluid, information on temperature of the fluid, and control state information corresponding to a control state of an apparatus installed inside or outside the pipe,
wherein the first passing route is a route not comprising the apparatus installed inside or outside the pipe among routes through which the fluid passes through the pipe, and
wherein the second passing route is a route comprising the apparatus installed inside or outside the pipe among routes through which the fluid passes through the pipe.

10. The apparatus of claim 9, wherein the measurement sensor comprises:
a pressure gauge configured to measure the pressure of the fluid;
a thermometer configured to measure the temperature of the fluid; and
a control state measuring instrument configured to measure the control state of the apparatus installed inside or outside the pipe.

11. The apparatus of claim 9, wherein the first parameter comprises a diameter of the pipe, roughness of an inner surface of the pipe, and a distance between pressure gauges.

12. The apparatus of claim 9, wherein the second parameter comprises a calculation formula of a pressure loss coefficient of the apparatus according to the control state information.

13. The apparatus of claim 9, wherein the outputting of the flow rate of the fluid comprises obtaining a friction coefficient of the pipe, which is necessary for calculating the flow rate of the fluid passing through the pipe, based on the physical properties of the fluid and the first parameter.

14. The apparatus of claim 13, wherein the outputting of the flow rate of the fluid comprises obtaining a pressure loss coefficient of the apparatus, which is necessary for calculating the flow rate of the fluid passing through the apparatus, based on the control state information and the second parameter.

15. The apparatus of claim 14, wherein the outputting of the flow rate of the fluid comprises:
generating a flow rate calculation model for calculating a flow velocity of the fluid based on the pipe information, the physical properties of the fluid, the first parameter, and the second parameter;
obtaining the flow velocity of the fluid by analyzing the flow rate calculation model; and
outputting the flow rate of the fluid based on the flow velocity of the fluid.

16. The apparatus of claim 15, wherein the obtaining of the flow velocity of the fluid comprises analyzing the flow rate calculation model using one of an analytical method, a numerical method, and a model estimation method.

17. A parameter training method comprising:
receiving an actual flow rate from a flow meter installed on a pipe through which fluid passes;
training a first parameter related to pressure loss of the fluid that occurs in a first passing route in the pipe and a second parameter related to pressure loss of the fluid that occurs in a second passing route in the pipe by comparing a flow rate measured from a flow rate measurement apparatus with the actual flow rate; and
storing the trained first parameter and the trained second parameter in a memory,
wherein the first passing route is a route not comprising an apparatus installed inside or outside the pipe among routes through which the fluid passes through the pipe, and
wherein the second passing route is a route comprising the apparatus installed inside or outside the pipe among routes through which the fluid passes through the pipe.

18. The parameter training method of claim 17, wherein the first parameter comprises a diameter of the pipe, roughness of an inner surface of the pipe, and a distance between pressure gauges.

19. The parameter training method of claim 17, wherein the second parameter comprises a calculation formula of a pressure loss coefficient of the apparatus according to control state information corresponding to a control state of an apparatus installed inside or outside the pipe.

20. The parameter training method of claim 17, wherein the training of the first parameter and the second parameter comprises training the first parameter and the second parameter through one of a gradient descent method or a genetic algorithm method, based on a difference between the flow rate measured from the flow rate measurement apparatus and the actual flow rate.
